(19) United States
(12) Patent Application Publication
(10) Pub. No.: US 2023/0100330 A1
(43) Pub. Date: Mar. 30, 2023

(54) BIDDER SUPPORT IN MULTI-ITEM MULTI-UNIT COMBINATORIAL AUCTIONS

(71) Applicant: Regents of the University of Minnesota, Minneapolis, MN (US)

(72) Inventors: Alok Gupta, Minneapolis, MN (US); Gediminas Adomavicius, Minneapolis, MN (US); Mochen Yang, Minneapolis, MN (US)

(73) Assignee: Regents of the University of Minnesota, Minneapolis, MN (US)

(21) Appl. No.: 17/952,896

(22) Filed: Sep. 26, 2022

Related U.S. Application Data
(60) Provisional application No. 63/248,633, filed on Sep. 27, 2021.

(51) Int. Cl. G06Q 30/08

(52) U.S. Cl. CPC G06Q 30/08

(57) ABSTRACT

A system for bidder support in combinatorial auctions includes a machine readable storage medium storing instructions and a processor to execute the instructions throughout a duration of an auction. The processor executes the instructions to receive bids for a multi-item multi-unit (MIMU) combinatorial auction. The processor executes the instructions to track the status of each sub-auction of the MIMU auction. The status for each sub-auction includes a value of the respective sub-auction and a last winning bid of the respective sub-auction. The processor executes the instructions to determine bidder support information including winning levels, deadness levels, winning bids, and live bids based on the status of each sub-auction. The system/method is applicable to a number of different auction types, including the forward MIMU-OR and MIMU-XOR auctions, reverse MIMU-OR and MIMU-XOR auctions, as well as special cases of MIMU auctions (SIMU auctions and MISU auctions) and MIMU auctions with special bidding constraints (batch-based MIMU auctions and hierarchical MIMU auctions).

### RELATED APPLICATIONS

This Non-Provisional patent application claims the benefit of the filing date of U.S. Provisional Patent Application Ser. No. 63/248,633, filed Sep. 27, 2021, entitled “BIDDER SUPPORT IN MULTI-ITEM MULTI-UNIT COMBINATORIAL AUCTIONS,” the entire teachings of which are incorporated herein by reference.

### BACKGROUND

In a general continuous multi-item multi-unit (MIMU) combinatorial auction, bidders are allowed to join, bid, and leave at any time during the course of the auction, without restrictions regarding the specific auction rules (e.g., auction formats, activity or bidding rules, etc.). Bids can be expressed using two canonical types of bidding languages, OR bidding and XOR bidding. Under OR bidding, multiple bids submitted by one bidder can potentially all be winning the auction. Under XOR bidding, at most one bid from a particular bidder can possibly win the auction.

In a combinatorial auction, bidders can place bids both on items individually and on bundles of items. It can lead to desirable allocative efficiency when the values of items being auctioned exhibit synergies and create significant economic benefits. However, applications of combinatorial auctions in large-scale consumer-oriented markets is very limited, partly because it is highly complex to participate. The combinatorial nature of the auction makes it hard for bidders to keep track of auction status. For example, in a typical multi-item combinatorial auction, the number of possible bundles that bidders can bid on increases exponentially with respect to the number of heterogeneous items, and finding the winning bids (i.e., winner determination) is computationally intractable. In MIMU auctions, specifically, winner determination is known to be NP-complete (nondeterministic polynomial-time complete). As a result, unless informed by the auctioneer, bidders have little information to determine whether their bids are winning or to formulate their bids in an effective manner.

For these and other reasons, a need exists for the present invention.

### SUMMARY

One example of a system for bidder support in auctions includes a machine readable storage medium storing instructions and a processor to execute the instructions throughout a duration of an auction. The processor executes the instructions to receive bids for a multi-item multi-unit XOR (MIMU-XOR) auction. The processor executes the instructions to track the status of each sub-auction of the MIMU-XOR auction. The status for each sub-auction includes a value of the respective sub-auction and a last winning bid of the respective sub-auction. The processor executes the instructions to determine bidder support information comprising winning levels, deadness levels, winning bids, and live bids based on the status of each sub-auction.

Another example of a system for bidder support in auctions includes a machine readable storage medium storing instructions and a processor to execute the instructions throughout a duration of an auction. The processor executes the instructions to receive bids for a multi-item multi-unit OR (MIMU-OR) auction. The processor executes the instructions to track the status of each sub-auction of the MIMU-OR auction. The status for each sub-auction includes a value of the respective sub-auction and a last winning bid of the respective sub-auction. The processor executes the instructions to determine bidder support information comprising winning levels, deadness levels, winning bids, and live bids based on the status of each sub-auction.

Another example of a system for bidder support in reverse auctions includes a machine readable storage medium storing instructions and a processor to execute the instructions throughout a duration of an auction. The processor executes the instructions to receive bids for a reverse multi-item multi-unit (MIMU) auction. The processor executes the instructions to track the status of each sub-auction of the reverse MIMU auction. The status for each sub-auction includes a cost of the respective sub-auction and a last winning bid of the respective sub-auction. The processor executes the instructions to determine bidder support information comprising winning levels, deadness levels, winning bids, and live bids based on the status of each sub-auction.

### BRIEF DESCRIPTION OF THE DRAWINGS

FIG. 1 is a block diagram illustrating one example of a system to provide bidder support in continuous combinatorial auctions.

FIG. 2 is a block diagram illustrating one example of a processing system for providing bidder support in multi-item multi-unit (MIMU) auctions.

FIGS. 3A-3G illustrate examples for providing bidder support in MIMU-XOR auctions.

FIGS. 4A-4F illustrate examples for providing bidder support in MIMU-OR auctions.

FIGS. 5A-5B illustrate examples for providing bidder support in batch-based MIMU auctions.

FIG. 5C illustrates one example for providing bidder support in hierarchical MIMU auctions.

FIG. 6 is a block diagram illustrating one example of a processing system for providing bidder support in reverse MIMU auctions.

FIGS. 7A-7E illustrate examples for providing bidder support in reverse MIMU-OR auctions.

FIGS. 8A-8E illustrate examples for providing bidder support in reverse MIMU-XOR auctions.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

A bidder support scheme, which depends only on information from actually submitted bids, includes three key pieces of bidding-related information provided on demand in real time including: (1) which bids are currently winning the auction (i.e., winner information) and which bids could potentially win the auction in the future (i.e., live bids information); (2) how much one needs to bid on a particular bundle to have it winning immediately, i.e., if the auction were to stop after this bid (i.e., winning level information); and (3) how much one needs to bid on a particular bundle to have a chance of winning it in the future (i.e., deadness level information).

An important concept underlying the bidder support scheme is sub-auctions. Sub-auctions act as the “building blocks” of the entire auction, which can be used to characterize the status of bids (e.g., winning or dead) and to calculate the winning and deadness levels. In the present disclosure, the systems and methods provide bidder support by tracking sub-auction information.

Previous bidder support has primarily focused on two basic and canonical types of combinatorial auctions: (1) the Multi-Item Single-Unit (MISU) auctions, where multiple heterogeneous items are being auctioned, one unit for each; and (2) the Single-Item Multi-Unit (SIMU) auctions, where multiple homogeneous units of one item are being auctioned. The present disclosure considers the general form of combinatorial auctions, namely the Multi-Item Multi-Unit (MTMU) auctions, where multiple heterogeneous items are being auctioned, and multiple units are available for each item. Each bid can cover an arbitrary set of items and arbitrary available number of units for each item.

Accordingly, disclosed herein are systems and methods for providing real-time auction information to bidders in a general multi-item multi-unit continuous combinatorial auction. Submitted bids are processed to compute the optimal allocation of the auction. To facilitate the participation, for any given bundle of interest and at any time during the auction, the system also computes the bidding prices required to win the bundle immediately in the auction or to be able to potentially win the bundle later in the auction. The proposed method to compute bidding prices satisfies the allocative fairness principle, in that bids placed later cannot win the auction just by “matching” the value of earlier bids. The system allows bidders to query the optimal allocation and bidding prices in real-time as the auction progresses, and achieves higher computational efficiency than common alternatives. The system can also easily be adapted to accommodate several other types of multi-item multi-unit combinatorial auctions, including special cases of multi-item multi-unit auctions (such as multi-item single-unit or single-item multi-unit auctions), auctions with bidding constraints, and reverse auctions.

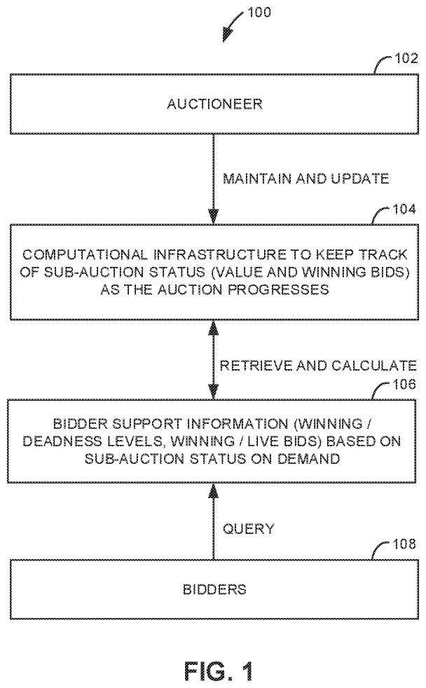

FIG. 1 is a block diagram illustrating one example of a system 100 to provide bidder support in continuous combinatorial auctions. System 100 includes an auctioneer at 102, a computational infrastructure 104, bidder support information 106, and bidders 108. The computational infrastructure keeps track of sub-actions status (e.g., value and winning bids) as the auction progresses. The auctioneer 102 maintains and updates the computational infrastructure 104. Data from computational infrastructure 104 is retrieved and calculated to provide the bidder support information 106. The bidder support information 106 provides winning/deadness levels, winning/live bids based on sub-auctions status on demand in response to queries from bidders 108.

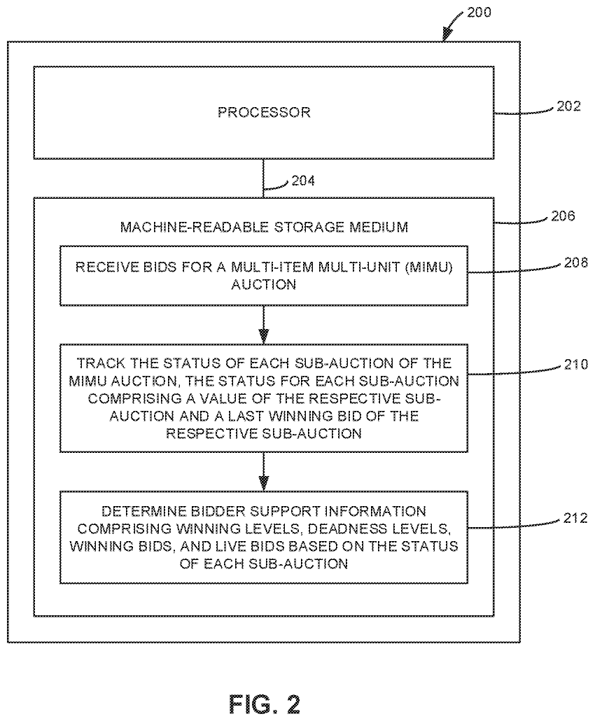

FIG. 2 is a block diagram illustrating one example of a processing system 200 for providing bidder support in multi-item multi-unit (MIMU) auctions. System 200 includes a processor 202 and a machine-readable storage medium 206. Processor 202 is communicatively coupled to machine-readable storage medium 206 through a communication path 204. Although the following description refers to a single processor and a single machine-readable storage medium, the description may also apply to a system with multiple processors and multiple machine-readable storage mediums. In such examples, the instructions and/or data may be distributed (e.g., stored) across multiple machine-readable storage mediums and the instructions and/or data may be distributed (e.g., executed/processed by) across multiple processors.

Processor 202 includes one or more central processing units (CPUs), microprocessors, and/or other suitable hardware devices for retrieval and execution of instructions and/or retrieval and processing of data stored in machine-readable storage medium 206. As will be described in more detail with reference to the following figures, processor 202 may fetch, decode, and execute instructions 208 to receive bids for a multi-item multi-unit (MIMU) auction. Processor 202 may fetch, decode, and execute instructions 210 to track the status of each sub-auction of the MIMU auction, the status for each sub-auction comprising a value of the respective sub-auction and a last winning bid of the respective sub-auction. Processor 202 may fetch, decode, and execute instructions 212 to determine bidder support information comprising winning levels, deadness levels, winning bids, and live bids based on the status of each sub-auction.

In one example, the MIMU auction may be a MIMU-XOR auction. In this case, each bid may include a bid span (i.e., the bundle on which the bid is placed), a bid value, a bidder identity, and a time of bid placement. Each sub-auction may include a particular span from all spans of the MIMU-XOR auction and a particular bidder coalition from all bidder coalitions of the MIMU-XOR auction. The processor 202 may execute further instructions to, for each bid received, update the value and the last winning bid for each sub-auction containing the received bid in response to the received bid being part of the winning bids for a given sub-auction. The update of the value and the last winning bid facilitates allocative fairness of MIMU-XOR auction outcomes. The processor 202 may execute further instructions to receive a wining level query from a bidder for a particular span; and in response to the winning level query, return a value based on a value of the entire MIMU-XOR auction and a value of a complementary sub-auction. The processor 202 may execute further instructions to compute a viable coalition set for a particular span for a particular bidder by examining whether possible bidder coalitions satisfy a certain condition. The processor 202 may execute further instructions to receive a deadness level query for a particular span for a particular bidder; and in response to the deadness level query, determine based on the viable coalition set corresponding to the particular span for the particular bidder, a smallest value among sub-auctions whose bidder coalitions belong to the viable coalition set. The processor 202 may execute further instructions to receive a winning bid query for a particular span and particular bidder coalition; and in response to the winning bid query, iteratively add each last winning bid to a win array and navigate to the complementary sub-auction, until the particular span of the last winning bid is zero or the particular bidder coalition of the last winning bid is empty. In one example, the MIMU-XOR auction may include a batch-based MIMU-XOR auction. In another example, the MIMU-XOR auction may include a hierarchical MUMU-XOR auction.

In another example, the MIMU auction may be a MIMU-OR auction. In this case, each bid may include a bid span, a bid value, and a time of bid placement. Each sub-auction may include a particular span from all spans of the MIMU-OR auction. The processor 202 may execute further instructions to update the value and the last winning bid for each sub-auction containing the received bid in response to the received bid being part of the winning bids for a given sub-auction. The update of the value and the last winning bid facilitates allocative fairness of MIMU-OR auction outcomes. The processor 202 may execute further instructions to receive a wining level query for a particular span; and in response to the winning level query, return a value based on a value of the entire MIMU-OR auction and a value of a complementary sub-auction. The processor 202 may execute further instructions to receive a deadness level query for a particular span; and in response to the deadness level query, determine based on all sub-auctions where the sub-auction span is greater than or equal to the particular span to find the smallest value. The processor 202 may execute further instructions to receive a winning bid query for a particular span at a particular state; and in response to the winning bid query, iteratively add each last winning bid to a win array and navigate to the complementary sub-auction, until the particular span of the last winning bid is zero or the particular state is zero. In one example, the MIMU-OR auction may include a batch-based MIMU-OR auction. In another example, the MTMU-OR auction may include a hierarchical MTMU-OR auction.

Machine-readable storage medium 206 is a non-transitory storage medium and may be any suitable electronic, magnetic, optical, or other physical storage device that stores executable instructions and/or data. Thus, machine-readable storage medium 206 may be, for example, random access memory (RAM), an electrically-erasable programmable read-only memory (EEPROM), a storage drive, an optical disc, and the like. Machine-readable storage medium 206 may be disposed within system 200, as illustrated in FIG. 2. In this case, the executable instructions and/or data may be installed on system 200. Alternatively, machine-readable storage medium 206 may be a portable, external, or remote storage medium that allows system 200 to download the instructions and/or data from the portable/external/remote storage medium. In this case, the executable instructions and/or data may be part of an installation package.

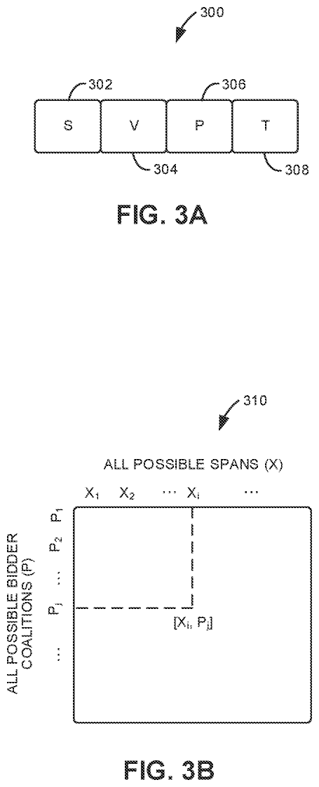

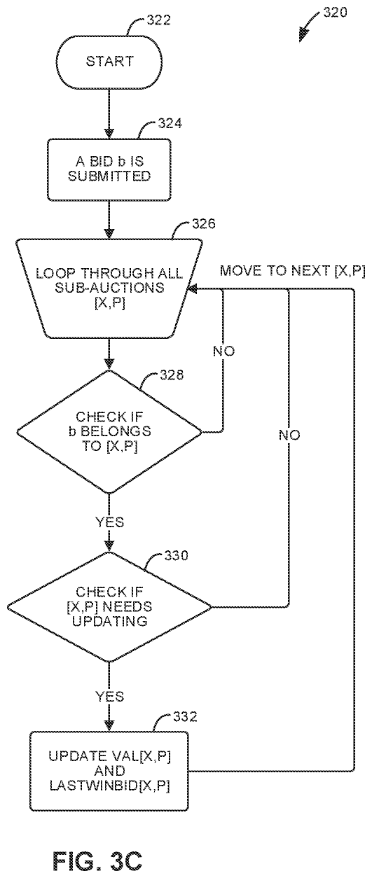

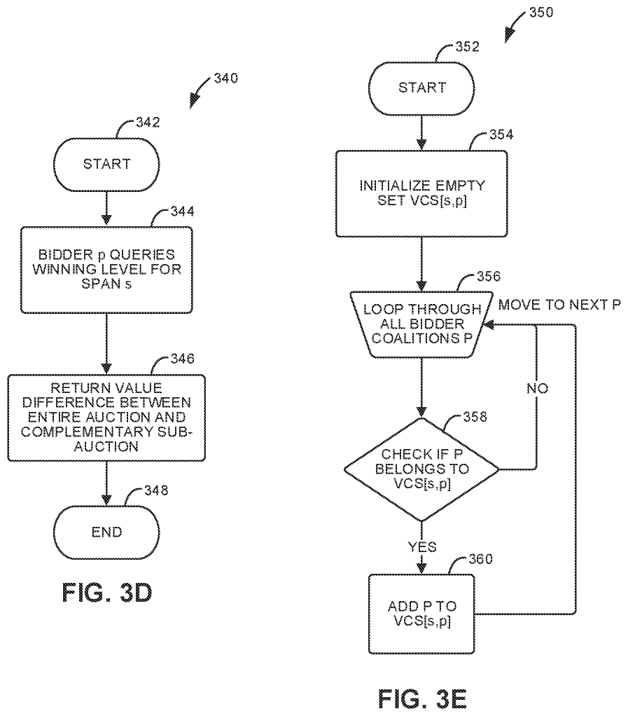

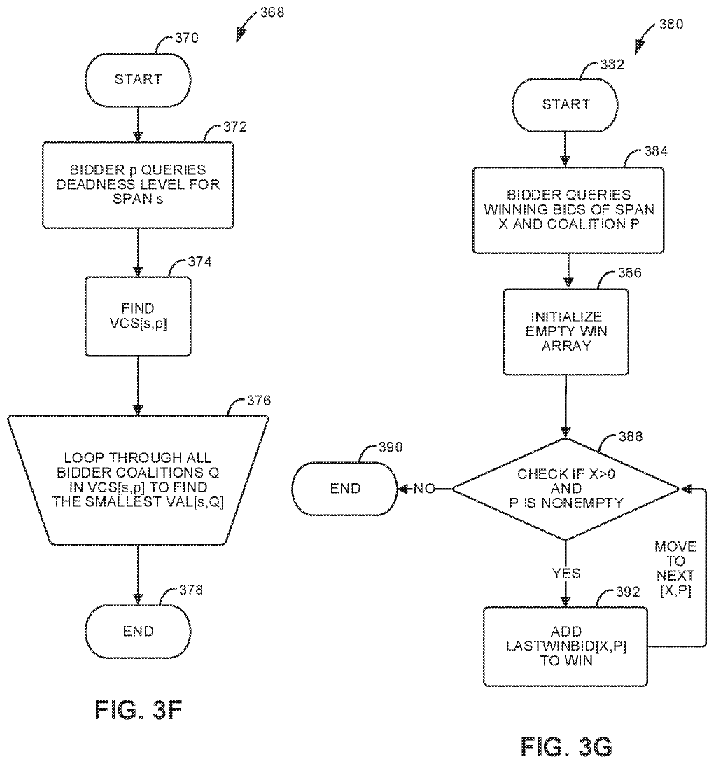

FIG. 3A illustrates one example of a representation 300 of an XOR bid in a MIMU auction. XOR bid 300 includes a bid span (s) 302, a value of the bid (v) 304, the identity of the bidder (p) 306, and the time of bid placement (t) 308. The bid span 302 is an index that represents the bundle (i.e., a number of units required for each specific item). The bid span can be implemented via several different approaches, such as vector representation or bitmap representation.

FIG. 3B illustrates one example of a representation 310 of a sub-auction in a MIMU-XOR auction. Two arrays of the structure depicted in FIG. 3B, respectively named VAL and LastWinBid, are created and stored. A sub-auction is defined by a particular span (X) and bidder coalition (P), and includes only bids that are placed on X or smaller spans by bidders from coalition P. VAL[X,P] stores the up-to-date value of sub-auction [X,P]. LastWinBid [X,P] stores the latest winning bid of sub-auction [X,P].

FIG. 3C is a flowchart illustrating one example of a method 320 for an incremental update in a MIMU-XOR auction. Method 320 starts at 322. At 324, a bid b is submitted. At 326, after a new bid, b=<s,v,p,t> is submitted, this procedure loops through all sub-auctions [X,P] to make incremental updates. At 328, method 320 checks if bid b belongs to [X,P]. Bid b belongs to sub-auction [X,P] if and only if its span s contains no more units on each item than span X, and p∈P. If bid b does not belong to [X,P], then method 320 moves to the next [X,P] and returns to 326. If bid b belongs to [X. P], then at 330 method 320 checks if [X,P] needs updating. Sub-auction [X,P] needs to be updated if and only if v+VAL[X−s,P\p]>VAL[X,P], i.e., the newly submitted bid combines with winning bids in complementary sub-auction [X−s,P\p] to strictly outbid current winning bids in [X,P]. This satisfies the allocative fairness criterion. If [X,P] does not need updating, then method 320 moves to the next [X,P] and returns to 326. If [X,P] does need updating, then at 332 sub-auction [X,P] is updated as follows: VAL[X,P]=v+VAL[X−s,P\p], LastWinBid [X,P]=b. Method 320 then moves to the next [X,P] and returns to 326.

FIG. 3D is a flowchart illustrating one example of a method 340 to query a winning level in a MIMU-XOR auction. Method 340 starts at 342. At 344, bidder p queries winning level for span s. At 346, method 340 returns a value difference between the entire auction and the complementary auction. Winning level for sub-auction [s,p] is defined as the minimal value that bidder p can place on span s in order to win the sub-auction immediately. Winning level for sub-auction [s,p] is computed as VAL[ [symbol] , [symbol] ]−VAL[N−s, [symbol] \p], where [symbol] is the span of the entire auction and [symbol] is the coalition that contains all bidders. At 348, method 340 ends.

FIG. 3E is a flowchart illustrating one example of a method 350 to find viable coalition set VCS in a MIMU-XOR auction. Method 350 starts at 352. At 354, for a particular bidder p and span s, method 350 initializes an empty array named VCS[s,p] to store the viable coalition set. At 356, method 350 loops through all bidder coalitions P. At 358, method 350 checks if P belongs to VCS[s,p]. Coalition P belongs to VCS[s,p] if and only if p∈P and |P|=max(1,| [symbol] |−[ [symbol] ]−s|). If P does not belong to VCS[s,p], then method 350 moves to the next P and returns to 356. If P does belong to VCS[s,p], then at 360 method 350 adds P to VCS[s,p].

FIG. 3F is a flowchart illustrating one example of a method 368 to query a deadness level in a MIMU-XOR auction. Method 368 starts at 370. At 372, bidder p queries deadness level for span s. At 374, method 368 finds VCS[s,p] using the procedure outlined in FIG. 3E. At 376, method 368 loops through all bidder coalitions Q in VCS[s,p] to find the smallest VCS[s,Q]. The deadness level for sub-auction [s,p] is defined as the minimal value that bidder p can place on span s in order to have a chance of winning the sub-auction sometime in the future. The deadness level is computed as

$${min}_{Q ∈ VCS [ s , p ]} VAL [ s , Q ] .$$

At 378, method 368 ends.

FIG. 3G is a flowchart illustrating one example of a method 380 to find winning bids of a sub sub-auction [X,P] in a MIMU-XOR auction. Method 380 starts at 382. At 384, a bidder queries winning bids of span X and coalition P. At 386, method 380 initializes an empty WIN array. At 388, method 380 checks if X>0 and P is nonempty. If X>0 and P is nonempty is false, then method 380 ends at 390. If X>0 and P is nonempty is true, then at 392 method 380 adds LastWinBid[X,P] to the WIN array, moves to the next [X,P], and returns to 388. For example, suppose LastWinBid [X,P]=<s,v,p,t>, then the next sub-auction to check is [X−s,P\p]. The same procedure can be used to find the winning bids of the entire auction, by setting X= [symbol] and P= [symbol] . The same procedure can also be used to find the set of all live bids, by repeating it for all sub-auctions [s,Q] with Q∈VCS[s,p].

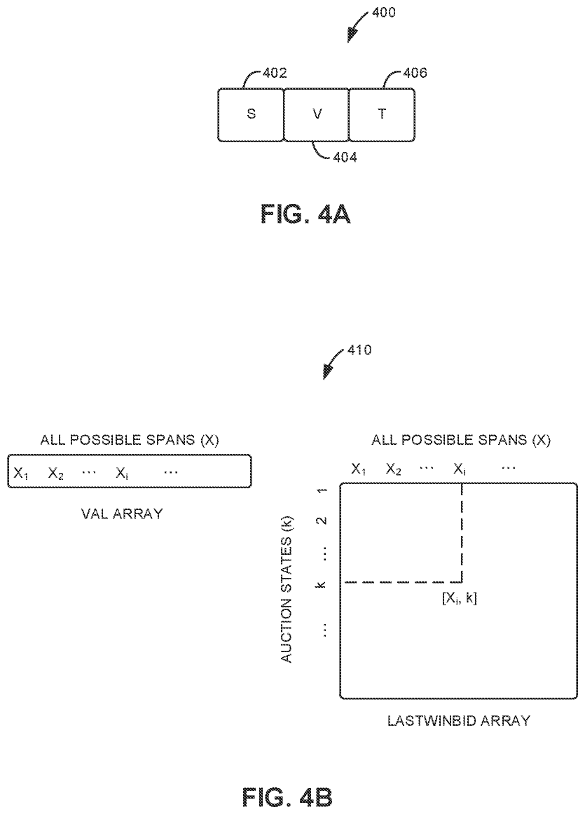

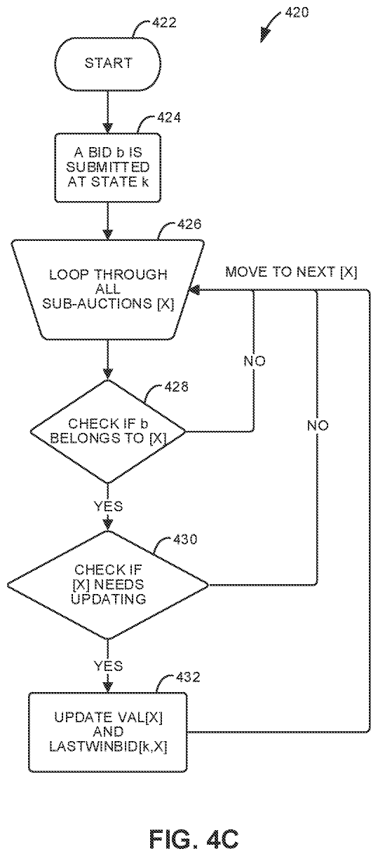

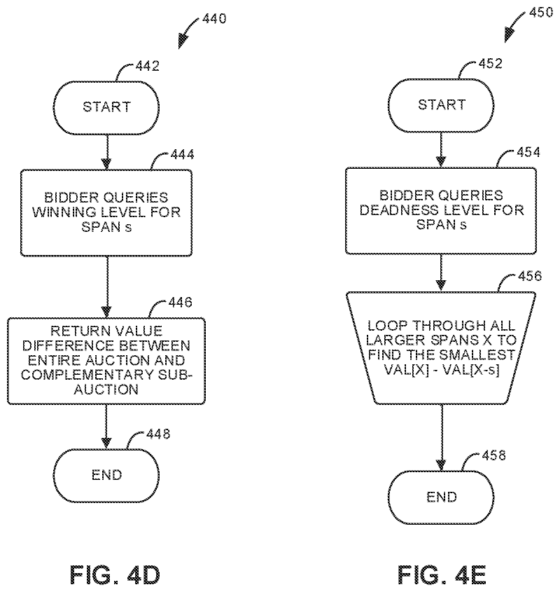

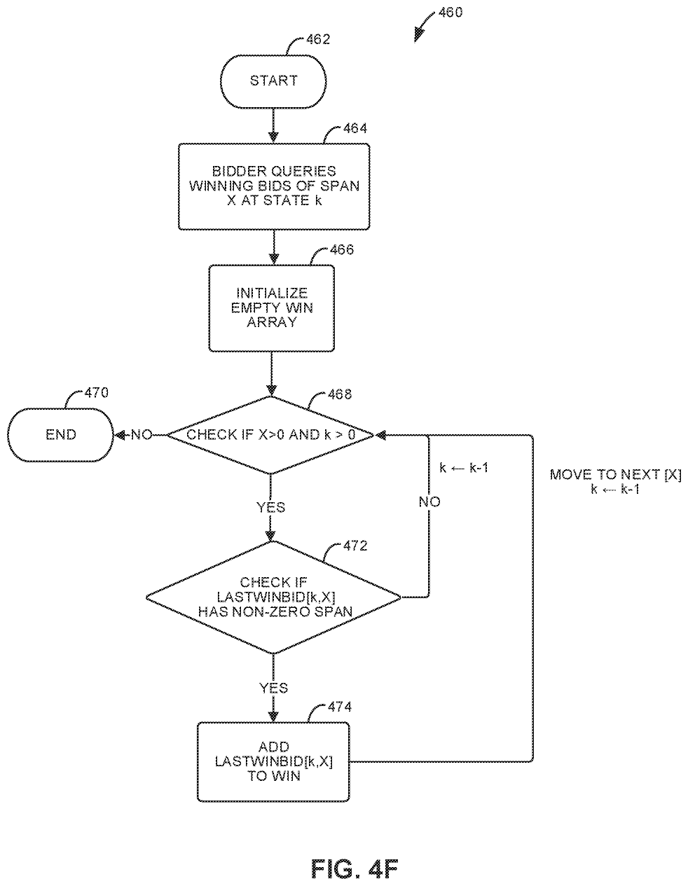

FIG. 4A illustrates one example of a representation 400 of an OR bid in a MIMU auction. OR bid 400 includes a bid span 402, a value of the bid 404, and the time of bid placement 406. The bid span 402 is an index that represents the bundle (i.e., a number of units required for each specific item). The bid span can be implemented via several different approaches, such as vector representation or bitmap representation.

FIG. 4B illustrates a representation 410 of a sub-auction in a MIMU-OR auction. Two arrays of the structures depicted in FIG. 4B, respectively named VAL and LastWinBid, are stored. A sub-auction is defined by a particular span (X), and includes only bids that are placed on X or smaller spans. VAL[X] stores the up-to-date value of sub-auction [X]. LastWinBid[k,X] stores the latest winning bid of sub-auction [X] at auction state k. The auction state k is an integer that increments by 1 for each submitted bid.

FIG. 4C is a flowchart illustrating one example of a method 420 for an incremental update in a MIMU-OR auction. Method 420 starts at 422. At 424, a bid b is submitted at state k. At 426, method 420 loops through all sub-auctions [X]. After a new bid, b=<s,v,t> is submitted, this procedure loops through all sub-auctions [X] to make incremental updates. At 428, method 420 checks if b belongs to [X]. Bid b belongs to sub-auction [X] if and only if its span s contains no more units on each item than span X. If b does not belong to [X], then method 420 moves to the next [X] and returns to 426. If b does belong to [X], then at 430 method 420 checks if [X] needs updating. Sub-auction [X] needs to be updated if and only if v+VAL[X−s]>VAL[X], i.e., the newly submitted bid combines with winning bids in complementary sub-auction [X−s] to strictly outbid current winning bids in [X]. This satisfies the allocative fairness criterion. If [X] does not need updating, then method 420 moves to the next [X] and returns to 426. If [X] does need updating, then at 432, method 420 updates VAL[X] and LastWinBid[k,X]. Sub-auction [X] is updated as follows: VAL[X]=v+VAL[X−s], LastWinBid [k,X]=b. Method 420 then moves to the next [X] and returns to 426.

FIG. 4D is a flowchart illustrating one example of a method 440 to query a winning level in a MIMU-OR auction. Method 440 starts at 442. At 444, a bidder queries a winning level for span s. At 446, method 440 returns a value difference between the entire auction and the complementary sub-auction. Winning level for sub-auction [s] is defined as the minimal value that any bidder can place on span s in order to win the sub-auction immediately. Winning level for sub-auction [s] is computed as VAL[ [symbol] ]−VAL[ [symbol] −s], where [symbol] is the span of the entire auction. At 448, method 440 ends.

FIG. 4E is a flowchart illustrating one example of a method 450 to query a deadness level in a MIMU-OR auction. Method 450 starts at 452. At 454, a bidder queries a deadness level for span s. At 456, method 450 loops through all larger spans X to find the smallest VAL[X]−VAL[X−s]. The deadness level for sub-auction [s] is defined as the minimal value that any bidder can place on span s in order to have a chance of winning the sub-auction sometime in the future. Method 450 loops through all sub-auctions X≥s, the deadness level is computed as

$${min}_{X : s \leq X \leq ℕ} [ VAL [ X ] - VAL [ X - s ] ] .$$

At 458, method 450 ends.

FIG. 4F is a flowchart illustrating one example of a method 460 to find winning bids of sub-auction [X] in a MIMU-OR auction. Method 460 starts at 462. At 464, a bidder queries winning bids of span X at state k. At 466, method 460 initializes an empty WIN array. At 468, method 460 checks if X>0 and k>0. If X>0 and k>0 is false, then method 460 ends at 470. If X>0 and k>0 is true, then at 472 method 460 checks if LastWinBid [k,X] has non-zero span. If LastWinBid [k,X] has zero span, then method 460 decrements the state variable k and returns to 468. If LastWinBid[k,X] has non-zero span, then at 474 method 460 adds LastWinBid[k,X] to the WIN array. Method 460 then decrements the state variable k, moves to the next [X], and returns to 468. For example, suppose LastWinBid[k,X]=<s,v,t>, then the next sub-auction to check is [X−s] at state k−1. The same procedure can be used to find the winning bids of the entire auction, by setting X= [symbol] . The same procedure can also be used to find the set of all live bids, by repeating it for all sub-auctions.

The system disclosed herein tracks the values and winning bids of all sub-auctions and updates them in a dynamic-programming fashion as the auction progresses. As a result, bidder support information can be queried very efficiently. Benchmarking analyses against an Integer Programming (IP) approach to compute bidder support information “on the fly” may be conducted. Using a straightforward IP formulation for winner determination, benchmarking analyses may be used to compare the running time of the disclosed approach against that of IP to calculate all the winning levels and deadness levels that can be queried by auction participants. Under both MIMU-XOR and MIMU-OR auction settings, the IP approach is several orders of magnitude slower than the disclosed approach in calculating all bidder support information. As an example, on a regular personal computer, it would take the IP approach more than 8 hours to calculate all winning and deadness levels for a MIMU-OR auction with 3 items and 15 units per item after one bid. In contrast, it takes the disclosed implementation only 5.25 milliseconds to do so on the same computer (i.e., the disclosed implementation achieves a speedup of 5.5 million times). Overall, the disclosed implementation trades exponential storage space for fast calculation of winning and deadness levels.

In addition to the general MIMU auctions, the disclosed system and method naturally supports special cases of MIMU auctions, including the Multi-Item Single-Unit (MISU) auctions and the Single-Item Multi-Unit (SIMU) auctions. Specifically, SIMU/MISU auctions are simplified MIMU auctions. A MIMU auction reduces to a SIMU auction with the constraint that there is a single item multiple available units, and reduces to a MISU auction with the constraint that there is a single unit available for each distinct item. Accordingly, based on these transformations in auction representation, one can map the methods to compute bidder support information from MIMU auctions to SIMU and MISU auctions.

Furthermore, the systems and methods to provide bidder support in general MIMU auctions can be straightforwardly applied to special cases, e.g., batch-based MIMU auctions and hierarchical MIMU auctions. In a batch-based MIMU auction, the span of a permitted bid must be multiples of a given batch size. This cardinality constraint is particularly relevant in industrial procurement contexts, where there might be capacity constraints in manufacturing or transportation that restrict the cardinality of bids. Taking a batch-based MIMU-OR auction as an example, all of the computational infrastructure designed for general MIMU-OR auctions is readily applicable, with a few minor modifications.

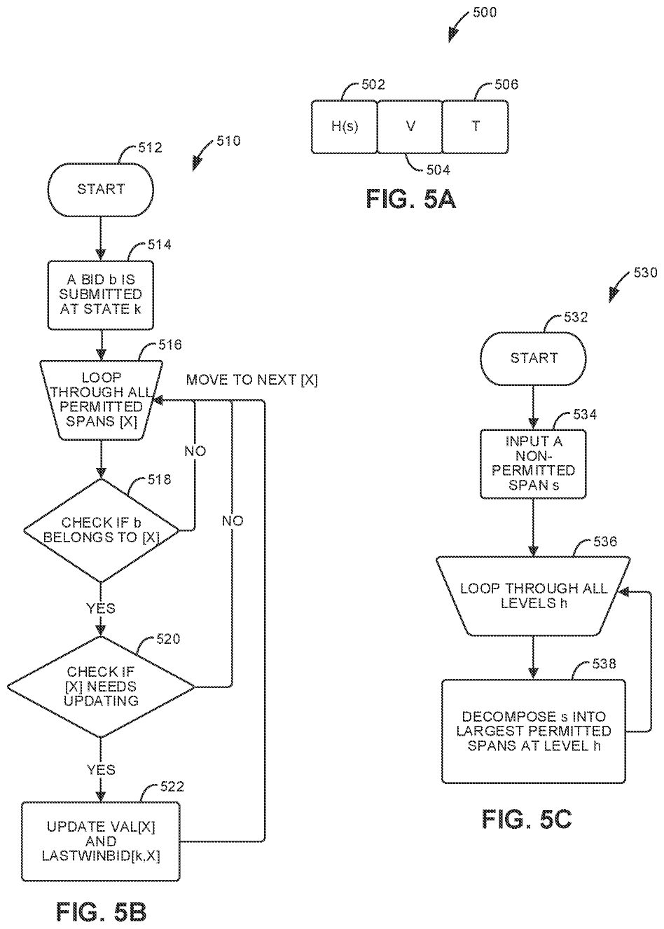

FIG. 5A illustrates one example of a representation 500 of an OR bid in a batch-based MIMU auction. OR bid 500 includes a bid span 502, a value of the bid 504, and a time of bid placement 506. The bid span 502 is an index that represents the bundle (i.e., a number of units required for each specific item). The bid span can be implemented via several different approaches, such as vector representation or bitmap representation. Function H(s) further maps all permitted spans to consecutive indices.

FIG. 5B is a flowchart illustrating one example of a method 510 for an incremental update in a batch-based MIMU-OR auction. Method 510 starts at 512. At 514, a bid b is submitted at state k. At 516, method 510 loops through all permitted spans [X]. After a new bid, b=<s,v,t> is submitted, this procedure loops through all permitted sub-auctions [X] to make incremental updates. At 518, method 510 checks if b belongs to [X]. Bid b belongs to sub-auction [X] if and only if its span s contains no more units on each item than span X. If b does not belong to [X], then method 510 moves to the next [X] and returns to 516. If b does belong to [X], then at 520 method 510 checks if [X] needs updating. Sub-auction [X] needs to be updated if and only if v+VAL[H(X−s)]>VAL[H(X)], i.e., the newly submitted bid combines with winning bids in complementary sub-auction [X−s] to outbid current winning bids in [X]. This satisfies the allocative fairness criterion. If [X] does not need updating, then method 510 moves to the next [X] and returns to 516. If [X] does need updating, then at 522 method 510 updates VAL[X] and LastWinBid[k,X]. Sub-auction [X] is updated as follows: VAL[H(X)]=v+VAL[H(X−s)], LastWinBid [k, H(X)]=b. Method 510 then moves to the next [X] and returns to 516.

In a hierarchical MIMU auction, permitted spans form a hierarchical structure (e.g., a tree structure). Hierarchical combinatorial auctions have straightforward practical relevance for auctioning spectrum licenses, where the permitted bundles may include individual licenses, regional licenses, and national licenses. All of the computational infrastructure designed for general MIMU-OR auctions are also readily applicable to hierarchical MIMU auctions.

FIG. 5C is a flowchart illustrating one example of a method 530 to decompose a non-permitted span in a hierarchical MIMU auction into a combination of multiple permitted spans, which is needed for incremental update. Method 530 starts at 532. At 534, method 530 inputs a non-permitted span s. At 536, method 530 loops through all levels h. At 538, method 530 decomposes s into largest permitted spans at level h and returns to 536. The procedure depicted in FIG. 5C recursively decomposes a non-permitted span into the combination of permitted ones by finding the largest permitted spans at each level of the hierarchy that can cover part of the non-permitted span. The disclosed decomposition approach guarantees that it is always possible to decompose any given non-permitted span.

The systems and methods disclosed herein for providing bidder support in general forward MIMU auctions can also be applied to the alternative combinatorial auction format known as the reverse auction, where multiple sellers compete with each other for the right to sell items to a buyer. Reverse auctions are commonly used in industrial procurements. A key distinction between the two auction formats is that, while buyers generally have to raise their bid values to win a forward auction, sellers have to lower their bid values to win a reverse auction.

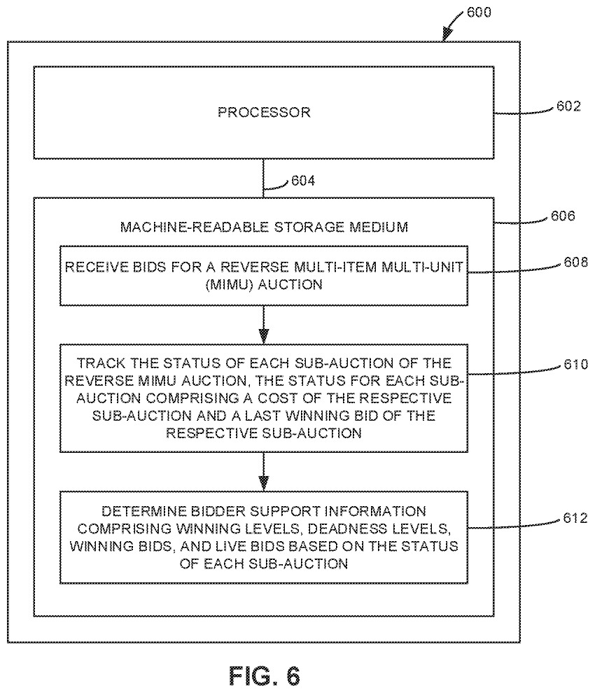

FIG. 6 is a block diagram illustrating one example of a processing system 600 for providing bidder support in reverse multi-item multi-unit (MIMU) auctions. System 600 includes a processor 602 and a machine-readable storage medium 606. Processor 602 is communicatively coupled to machine-readable storage medium 606 through a communication path 604. Although the following description refers to a single processor and a single machine-readable storage medium, the description may also apply to a system with multiple processors and multiple machine-readable storage mediums. In such examples, the instructions and/or data may be distributed (e.g., stored) across multiple machine-readable storage mediums and the instructions and/or data may be distributed (e.g., executed/processed by) across multiple processors.

Processor 602 includes one or more CPUs, microprocessors, and/or other suitable hardware devices for retrieval and execution of instructions and/or retrieval and processing of data stored in machine-readable storage medium 606. As will be described in more detail with reference to the following figures, processor 602 may fetch, decode, and execute instructions 608 to receive bids for a reverse multi-item multi-unit (MIMU) auction. Processor 602 may fetch, decode, and execute instructions 610 of to track the status of each sub-auction of the reverse MIMU auction, the status for each sub-auction comprising a cost of the respective sub-auction and a last winning bid of the respective sub-auction. Processor 602 may fetch, decode, and execute instructions 612 to determine bidder support information comprising winning levels, deadness levels, winning bids, and live bids based on the status of each sub-auction.

Processor 602 may execute further instructions to, for each bid received, update the cost and the last winning bid for each sub-auction corresponding to the received bid in response to the received bid being part of the winning bids for a given sub-auction. The update of the cost and the last winning bid facilitates allocative fairness of reverse MIMU auction outcomes. Processor 602 may execute further instructions to receive a wining level query for a particular span; and in response to the winning level query, return a value based on a cost of the entire reverse MIMU auction and a cost of a complementary sub-auction.

In one example, the MIMU auction may be a reverse MIMU-OR auction. In this case, each bid may include a bid span, a bid cost, and a time of bid placement. Each sub-auction may include a particular span from all spans of the reverse MIMU-OR auction. Processor 602 may execute further instructions to receive a deadness level query for a particular span; and in response to the deadness level query, determine based on all sub-auctions where the sub-auction span has a non-empty overlap with the particular span to find the maximum cost.

In another example, the MIMU auction may be a reverse MIMU-XOR auction. In this case, each bid comprises a bid span, a bid cost, a bidder identity, and a time of bid placement. Each sub-auction may include a particular span from all spans of the reverse MIMU-XOR auction and a particular bidder coalition from all bidder coalitions of the reverse MIMU-XOR auction. Processor 600 may execute further instructions to receive a deadness level query for a particular span for a particular bidder; and in response to the deadness level query, determine based on the viable coalition set corresponding to the particular span for the particular bidder, a largest cost among sub-auctions whose bidder coalitions belong to the viable coalition set.

Machine-readable storage medium 606 is a non-transitory storage medium and may be any suitable electronic, magnetic, optical, or other physical storage device that stores executable instructions and/or data. Thus, machine-readable storage medium 606 may be, for example, RAM, an EEPROM, a storage drive, an optical disc, and the like. Machine-readable storage medium 606 may be disposed within system 600, as illustrated in FIG. 6. In this case, the executable instructions and/or data may be installed on system 600. Alternatively, machine-readable storage medium 606 may be a portable, external, or remote storage medium that allows system 600 to download the instructions and/or data from the portable/external/remote storage medium. In this case, the executable instructions and/or data may be part of an installation package.

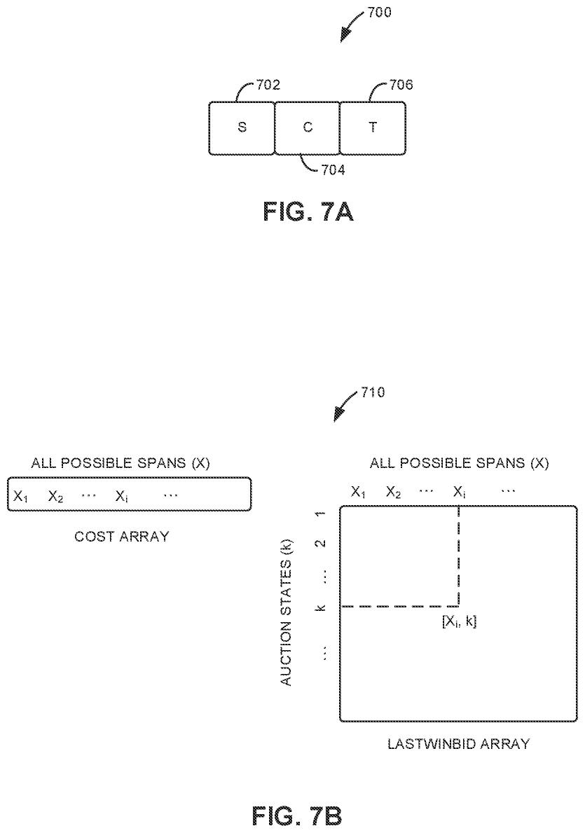

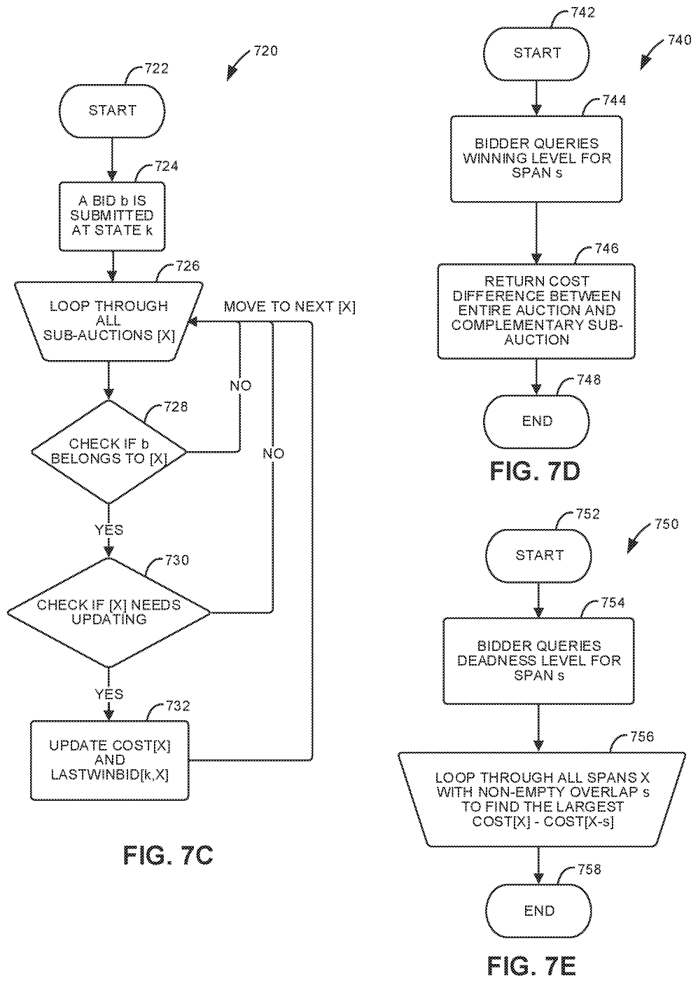

FIG. 7A illustrates one example of a representation 700 of an OR bid in a reverse MIMU-OR auction. OR bid 700 includes a bid span 702, a cost of the bid 704, and the time of bid placement 706. The bid span 702 is an index that represents the bundle (i.e., a number of units required for each specific item). The bid span can be implemented via several different approaches, such as vector representation or bitmap representation. Because the auctioneer in a reverse auction is typically the buyer of certain assets, the main objective is typically cost minimization (rather than value maximization in forward auctions). Accordingly, the value of a bid represents the cost of procuring the items specified in the bid.

FIG. 7B illustrates a representation 710 of a sub-auction in a reverse MIMU-OR auction. Two arrays of the structures depicted in FIG. 7B, respectively named COST and LastWinBid, are stored. A sub-auction is defined by a particular span (X), and include all bids whose spans have non-empty intersection with X. COST[X] stores the up-to-date cost of sub-auction [X]. LastWinBid[k,X] stores the latest winning bid of sub-auction [X] at auction state k.

FIG. 7C is a flowchart illustrating one example of a method 720 for an incremental update in a reverse MIMU-OR auction. Method 720 starts at 722. At 724, a bid b is submitted at state k. At 726, method 720 loops through all sub-auctions [X]. After a new bid, b=<s, c, t> is submitted, this procedure loops through all sub-auctions [X] to make incremental updates. At 728, method 720 checks if b belongs to [X]. Bid b belongs to sub-auction [X] if and only if its span s has non-empty intersection with span X, which means that s and X are bidding on at least one common item. If b does not belong to [X], then method 720 moves to the next [X] and returns to 726. If b does belong to [X], then at 730, method 720 checks if [X] needs updating. Sub-auction [X] needs to be updated if and only if c+COST[X⊖s]<COST[X], i.e., the newly submitted bid combines with winning bids in complementary sub-auction [X⊖s] to strictly outbid current winning bids in [X]. This satisfies the allocative fairness criterion. The ⊖ operator for two span vectors \vec{x}=(x₁, . . . , x_{M}) and \vec{y}=(y₁ . . . y_{M}) is defined as \vec{x}⊖\vec{y}=(max(xⱼ−yⱼ,0)ⱼ₌₁^{M}. If [X] does not need updating, then method 720 moves to the next [X] and returns to 726. If [X] does need updating, then at 732 method 720 updates COST[X] and LastWinBid[k,X]. Sub-auction [X] is updated as follows: COST [X]=c+COST [X⊖s], LastWinBid [k,X]=b. Method 720 then moves to the next [X] and returns to 726.

FIG. 7D is a flowchart illustrating one example of a method 740 to query a winning level in a reverse MIMU-OR auction. Method 740 starts at 742. At 744, a bidder queries a winning level for span s. At 746, method 740 returns a cost difference between the entire auction and the complementary auction. Winning level for sub-auction [s] is defined as the maximum asking price for span s in order to win the sub-auction immediately. Winning level for sub-auction [s] is computed as COST[ [symbol] ]−COST[ [symbol] −s], where [symbol] is the span of the entire auction. At 748, method 740 ends.

FIG. 7E is a flowchart illustrating one example of a method 750 to query a deadness level in a reverse MIMU-OR auction. Method 750 starts at 752. At 754, a bidder queries a deadness level for span s. At 756, method 750 loops through all spans X with non-empty overlap s to find the largest COST[X]−COST[X∈s]. The deadness level for sub-auction [s] is defined as the maximum asking price for span s in order to have a chance of winning the sub-auction sometime in the future. Method 750 loops through all sub-auctions X that has non-empty intersection with s. Denote those sub-auctions as a set [symbol] (s)={X|X∩s≠0}. The deadness level is computed as

$$[ COST [ X ] - COST [ X ⊖ s ] ] .$$

At 758, method 750 ends.

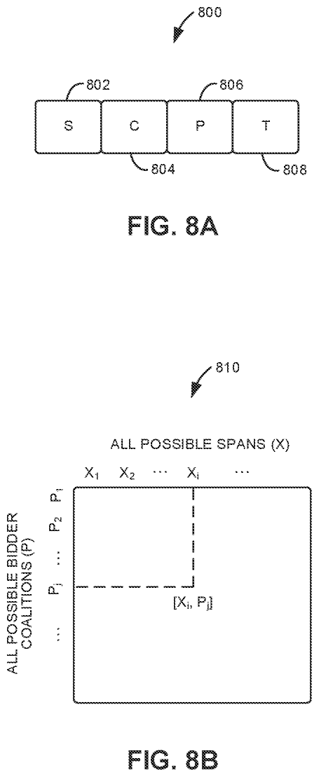

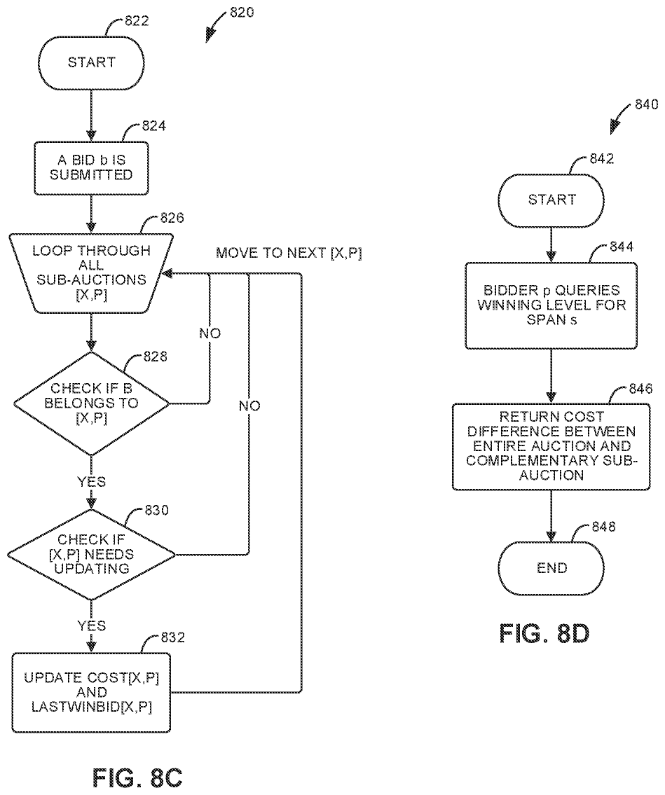

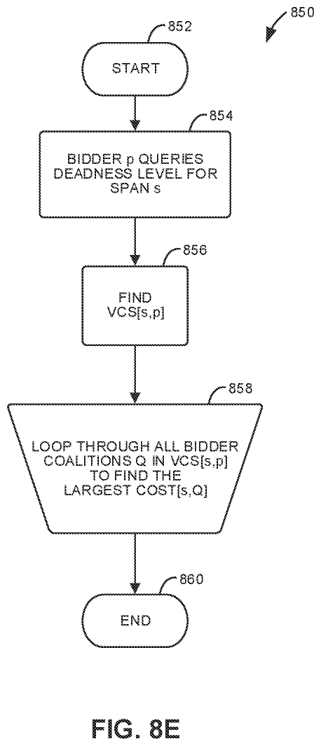

FIG. 8A illustrates one example of a representation 800 of an XOR bid in a reverse MIMU-XOR auction. XOR bid 800 includes a bid span 802, a cost of the bid 804, the identity of the bidder 806, and the time of bid placement 808. The bid span 802 is an index that represents the bundle (i.e., a number of units required for each specific item). The bid span can be implemented via several different approaches, such as vector representation or bitmap representation. Because the auctioneer in a reverse auction is typically the buyer of certain assets, the main objective is typically cost minimization (rather than value maximization in forward auctions). Accordingly, the value of a bid represents the cost of procuring the items specified in the bid.

FIG. 8B illustrates one example of a representation 810 of a sub-auction in a reverse MIMU-XOR auction. Two arrays of the structure depicted in FIG. 8B, respectively named COST and LastWinBid, are stored. A sub-auction is defined by a particular span (X) and bidder coalition (P), and include all bids whose spans have non-empty intersection with X and by bidders in coalition P. COST[X,P] stores the up-to-date cost of sub-auction [X,P]. LastWinBid[X,P] stores the latest winning bid of sub-auction [X,P].

FIG. 8C is a flowchart illustrating one example of a method 820 for an incremental update in a reverse MIMU-XOR auction. Method 820 starts at 822. At 824, a bid b is submitted. At 826, after a new bid, b=<s,c,p,t> is submitted, this procedure loops through all sub-auctions [X,P] to make incremental updates. At 828, method 820 checks if bid b belongs to [X,P]. Bid b belongs to sub-auction [X,P] if and only if its span s has non-empty intersection with span X (which means that s and X are bidding on at least one common item) and p∈P. If bid b does not belong to [X,P], then method 820 moves to the next [X,P] and returns to 826. If bid b belongs to [X,P], then at 830 method 820 checks if [X,P] needs updating. Sub-auction [X,P] needs to be updated if and only if c+COST[X⊖s,P\p]<COST[X,P], i.e., the newly submitted bid combines with winning bids in complementary sub-auction [X⊖s,P\p] to strictly outbid current winning bids in [X,P]. This satisfies the allocative fairness criterion. The ⊕ operator for two span vectors \vec{x}=(x₁, . . . , x_{M}) and \vec{y}=(y₁, . . . , y_{M}) is defined as \vec{x}⊖\vec{y}=(max(xⱼ−yⱼ,0))ⱼ₌₁^{M}. If [X,P] does not need updating, then method 820 moves to the next [X,P] and returns to 826. If [X,P] does need updating, then at 832 method 820 updates COST[X,P] and LastWinBid [X,P]. Sub-auction [X,P] is updated as follows: COST [X,P]=c+COST [X⊖s,P\p], LastWinBid [X,P]=b. Method 820 then moves to the next [X,P] and returns to 826.

FIG. 8D is a flowchart illustrating one example of a method 840 to query a winning level in a reverse MIMU-XOR auction. Method 840 starts at 842. At 844, a bidder queries a winning level for span s. At 846, method 840 returns a cost difference between the entire auction and the complementary sub-auction. Winning level for sub-auction [s,p] is defined as the maximum asking price that bidder p can place on span s in order to win the sub-auction immediately. Winning level for sub-auction [s,p] is computed as COST[ [symbol] , [symbol] ]−COST[ [symbol] −s, [symbol] \p], where N is the span of the entire auction and P is the coalition that contains all bidders. At 848, method 840 ends.

FIG. 8E is a flowchart illustrating one example of a method 850 to query a deadness level in a reverse MIMU-XOR auction. Method 850 starts at 852. At 854, a bidder queries a deadness level for span s. At 856, method 850 finds VCS[s,p] using the procedure outlined in FIG. 3E. At 858, method 850 loops through all bidder coalitions Q in VCS[s,p] to find the largest COST[s,Q]. The deadness level for sub-auction [s,p] is defined as the maximum asking price that bidder p can place on span s in order to have a chance of winning the sub-auction sometime in the future. The deadness level is computed as

$${max}_{Q ∈ VCS [ s , p ]} COST ( s , Q ) .$$

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system for bidder support in auctions comprising:
a machine readable storage medium storing instructions; and
a processor to execute the instructions throughout a duration of an auction to:
receive bids for a multi-item multi-unit XOR (MIMU-XOR) auction;
track the status of each sub-auction of the MIMU-XOR auction, the status for each sub-auction comprising a value of the respective sub-auction and a last winning bid of the respective sub-auction; and
determine bidder support information comprising winning levels, deadness levels, winning bids, and live bids based on the status of each sub-auction.

2. The system of claim 1, wherein each bid comprises a bid span, a bid value, a bidder identity, and a time of bid placement.

3. The system of claim 1, wherein each sub-auction comprises a particular span from all spans of the MIMU-XOR auction and a particular bidder coalition from all bidder coalitions of the MIMU-XOR auction.

4. The system of claim 1, wherein the processor is to execute the instructions to, for each bid received:
update the value and the last winning bid for each sub-auction containing the received bid in response to the received bid being part of the winning bids for a given sub-auction.

5. The system of claim 4, wherein the update of the value and the last winning bid facilitates allocative fairness of MIMU-XOR auction outcomes.

6. The system of claim 1, wherein the processor is to execute the instructions to:
receive a wining level query from a bidder for a particular span; and
in response to the winning level query, return a value based on a value of the entire MIMU-XOR auction and a value of a complementary sub-auction.

7. The system of claim 3, wherein the processor is to execute the instructions to:
compute a viable coalition set for a particular span for a particular bidder by examining whether possible bidder coalitions satisfy a certain condition.

8. The system of claim 7, wherein the processor is to execute the instructions to:
receive a deadness level query for a particular span for a particular bidder; and
in response to the deadness level query, determine based on the viable coalition set corresponding to the particular span for the particular bidder, a smallest value among sub-auctions whose bidder coalitions belong to the viable coalition set.

9. The system of claim 1, wherein the processor is to execute the instructions to:
receive a winning bid query for a particular span and particular bidder coalition; and
in response to the winning bid query, iteratively add each last winning bid to a win array and navigate to the complementary sub-auction, until the particular span of the last winning bid is zero or the particular bidder coalition of the last winning bid is empty.

10. The system of claim 1, wherein the MIMU-XOR auction comprises a batch-based MIMU-XOR auction.

11. The system of claim 1, wherein the MIMU-XOR auction comprises a hierarchical MIMU-XOR auction.

12. A system for bidder support in auctions comprising:
a machine readable storage medium storing instructions; and
a processor to execute the instructions throughout a duration of an auction to:
receive bids for a multi-item multi-unit OR (MTMU-OR) auction;
track the status of each sub-auction of the MIMU-OR auction, the status for each sub-auction comprising a value of the respective sub-auction and a last winning bid of the respective sub-auction; and
determine bidder support information comprising winning levels, deadness levels, winning bids, and live bids based on the status of each sub-auction.

13. The system of claim 12, wherein each bid comprises a bid span, a bid value, and a time of bid placement.

14. The system of claim 12, wherein each sub-auction comprises a particular span from all spans of the MIMU-OR auction.

15. The system of claim 12, wherein the processor is to execute the instructions to, for each bid received:
update the value and the last winning bid for each sub-auction containing the received bid in response to the received bid being part of the winning bids for a given sub-auction.

16. The system of claim 15, wherein the update of the value and the last winning bid facilitates allocative fairness of MIMU-OR auction outcomes.

17. The system of claim 12, wherein the processor is to execute the instructions to:
receive a wining level query for a particular span; and
in response to the winning level query, return a value based on a value of the entire MIMU-OR auction and a value of a complementary sub-auction.

18. The system of claim 12, wherein the processor is to execute the instructions to:
receive a deadness level query for a particular span; and
in response to the deadness level query, determine based on all sub-auctions where the sub-auction span is greater than or equal to the particular span to find the smallest value.

19. The system of claim 12, wherein the processor is to execute the instructions to:
receive a winning bid query for a particular span at a particular state; and
in response to the winning bid query, iteratively add each last winning bid to a win array and navigate to the complementary sub-auction, until the particular span of the last winning bid is zero or the particular state is zero.

20. The system of claim 12, wherein the MIMU-OR auction comprises a batch-based MIMU-OR auction.

21. The system of claim 12, wherein the MIMU-OR auction comprises a hierarchical MIMU-OR auction.

22. A system for bidder support in reverse auctions comprising:
a machine readable storage medium storing instructions; and
a processor to execute the instructions throughout a duration of an auction to:
receive bids for a reverse multi-item multi-unit (MIMU) auction;
track the status of each sub-auction of the reverse MIMU auction, the status for each sub-auction comprising a cost of the respective sub-auction and a last winning bid of the respective sub-auction; and
determine bidder support information comprising winning levels, deadness levels, winning bids, and live bids based on the status of each sub-auction.

23. The system of claim 22, wherein the processor is to execute the instructions to, for each bid received:
update the cost and the last winning bid for each sub-auction corresponding to the received bid in response to the received bid being part of the winning bids for a given sub-auction.

24. The system of claim 23, wherein the update of the cost and the last winning bid facilitates allocative fairness of reverse MIMU auction outcomes.

25. The system of claim 22, wherein the processor is to execute the instructions to:
receive a wining level query for a particular span; and
in response to the winning level query, return a value based on a cost of the entire reverse MIMU auction and a cost of a complementary sub-auction.

26. The system of claim 22, wherein the reverse MIMU auction comprises a reverse MIMU-OR auction.

27. The system of claim 26, wherein each bid comprises a bid span, a bid cost, and a time of bid placement.

28. The system of claim 26, wherein each sub-auction comprises a particular span from all spans of the reverse MIMU-OR auction.

29. The system of claim 26, wherein the processor is to execute the instructions to:
receive a deadness level query for a particular span; and
in response to the deadness level query, determine based on all sub-auctions where the sub-auction span has a non-empty overlap with the particular span to find the maximum cost.

30. The system of claim 26, wherein the processor is to execute the instructions to:
receive a winning bid query for a particular span at a particular state; and
in response to the winning bid query, iteratively add each last winning bid to a win array and navigate to the complementary sub-auction, until the particular span of the last winning bid is zero or the particular state is zero.

31. The system of claim 22, wherein the reverse MIMU auction comprises a reverse MIMU-XOR auction.

32. The system of claim 31, wherein each bid comprises a bid span, a bid cost, a bidder identity, and a time of bid placement.

33. The system of claim 31, wherein each sub-auction comprises a particular span from all spans of the reverse MIMU-XOR auction and a particular bidder coalition from all bidder coalitions of the reverse MIMU-XOR auction.

34. The system of claim 31, wherein the processor is to execute the instructions to:
receive a deadness level query for a particular span for a particular bidder; and
in response to the deadness level query, determine based on the viable coalition set corresponding to the particular span for the particular bidder, a largest cost among sub-auctions whose bidder coalitions belong to the viable coalition set.

35. The system of claim 31, wherein the processor is to execute the instructions to:
receive a winning bid query for a particular span and particular bidder coalition; and
in response to the winning bid query, iteratively add each last winning bid to a win array and navigate to the complementary sub-auction, until the particular span of the last winning bid is zero or the particular bidder coalition of the last winning bid is empty.
